(19) United States
(12) Patent Application Publication
(10) Pub. No.: US 2020/0191354 A1
(43) Pub. Date: Jun. 18, 2020

(54) LIGHT GUIDE DEVICE

(71) Applicant: G.SKILL International Enterprise Co., Ltd., Taipei (TW)

(72) Inventor: Chiung-Huang HUANG, Taipei (TW)

(21) Appl. No.: 16/801,464

(22) Filed: Feb. 26, 2020

Related U.S. Application Data
(63) Continuation-in-part of application No. 16/196,553, filed on Nov. 20, 2018, now Pat. No. 10,598,841.

(51) Int. Cl. F21V 5/00; F21V 17/06

(52) U.S. Cl. CPC F21V 5/00; F21V 17/06

(57) ABSTRACT

A light guide device includes a base with the light-incident surface facing toward the light-emitting side of light-emitting devices, and light guide components each having three or more light-emitting surfaces respectively define with the base a respective contained angle for causing a glare effect when light passes through the respective light guide components. The light guide components guide the incident light to the entire light guide device to improve the uniformity of the overall brightness, enabling the light guide device to emit a transparent and bright aesthetic sense and to produce a glare effect that looks like aurora.

This application is a Continuation-In-Part of application Ser. No. 16/196,553, filed on Nov. 20, 2018, for which priority is claimed under 35 U.S.C. § 120, the entire contents of which are hereby incorporated by reference.

### BACKGROUND OF THE INVENTION

### 1. Field of the Invention

The present invention relates to light guide technology and more particularly, to a light guide device for use in computers and computer peripheral devices, which uses a plurality of continuously connected and irregularly configured light guide components to improve brightness uniformity by guiding light to the overall area of the light guide device, so that the light projecting distance and range are increased, producing aurora-like glare effects and achieving uniform brightness, dazzling and wide light output.

### 2. Description of the Related Art

Generally, light guide devices are mostly used in backlight units of liquid crystal displays. When a light guide device is used to display a liquid crystal display, its brightness will be more uniform. With the improvement in computer performance and efficiency, memories, processors and other computer peripheral devices (such as keyboards, etc.) for use in computer systems have also flourished. At present, the memory device used in e-sports products had the requirement of sound and light effects. Therefore, light-emitting devices (such as light-emitting diodes) are usually installed on the memory, and a light guide device is arranged on the outside of the light-emitting devices. The light-emitting devices emit light toward the outside. The light guide device is then used to project the light farther outward, thereby achieving good lighting, visual and aesthetic effects.

However, the demand for light guide devices used in computer peripherals is to increase the light projection distance and the overall aesthetics, so the light guide devices used in liquid crystal displays do not meet the needs of computer peripherals. Moreover, most of the light guide devices for use in computer peripherals are designed to be flat strips. After the light passes through the light guide device, it will only be scattered outwardly. A light guide device through such a design makes the optical visual effect too tedious and cannot have a gorgeous light refraction effect. It is difficult to attract consumers' attention.

Therefore, how to solve the above-mentioned problems and inconvenience is the direction that the relevant industry is eager to study and improve.

### SUMMARY OF THE INVENTION

The present invention has been accomplished under the circumstances in view. It is a first object of the present invention to provide a light guide device, which comprises a base provided with a light-incident surface at one side thereof to face the light-emitting side of a plurality of predetermined light-emitting devices, and a plurality of continuously connected and irregularly configured light guide components located on at least one side of said base for improving the uniformity of brightness. Each light guide component has at least three light-emitting surfaces for refracting incident light. Each light-emitting surface defines with the base a respective contained angle. The arrangement of the continuously connected and irregularly configured light guide components on at least one side of the base of the light guide device is capable of unevenly projecting light passing therethrough toward the outside, therefore, the light guide components guide the light to the entire light guide device to improve the uniformity of the overall brightness of the light guide device, enabling the light guide device to emit a transparent and bright aesthetic sense. Uniform brightness can be used to prevent the viewer from seeing the light-emitting devices directly and avoiding glaring and uncomfortable eyes. In addition, at least one contained angle of at least one light guide component is different from at least one contained angle of another light guide component, the plural light guide components of the light guide device can make the light emitted by the light-emitting devices to be unevenly outputted, which can effectively increase the range and distance of light projection, and can produce a glare effect that looks like aurora. In this way, the light output effect can be more dazzling and gorgeous, so as to improve the aesthetics of the projected light, thereby increasing the consumer's desire to buy.

It is a second object of the present invention to provide a light guide device, which uses the continuously connected and irregularly configured light guide components to improve the overall brightness uniformity and the light projection distance and range. Therefore, the amount of light diffusing agent can be reduced or no light diffusing agent is required. Thus, the quantity of the light-emitting devices can be minimized, reducing the overall manufacturing cost. Furthermore, the light emitted by the light-emitting devices is refracted by the light guide components, avoiding uneven brightness and fogging, so that it can have better brightness uniformity and increased projection distance and projection range.

It is a third object of the present invention to provide a light guide device, which is so configured that after installation of the light guide device on the memory, the light-emitting devices are located right below the light-emitting surfaces of the light guide components, and are not located at the intersections of the light-emitting surfaces. When the light-emitting devices emit light upward, the light-emitting surfaces produce good refracting effects without refracting light onto the intersections of the light-emitting surfaces, eliminating the problem of being too bright or too dark and further improving the overall brightness intensity of the light guide device and the brightness uniformity.

It is a fourth object of the present invention to provide a light guide device, which is so configured that the light guide components that are arranged on the light guide device to face the light-emitting devices include two outer light guide components and a plurality of inner light guide components of two different heights alternatively arranged between the two outer light guide components, and the two outer light guide components are higher than the relatively shorter inner light guide components. This arrangement achieves better continuity of the light source, thereby improving brightness uniformity. Since the two outer light guide components is relatively higher than inner light guide components, the light projecting distance is effectively increased. This can improve the uniformity of brightness, as well as the effect of light output distance and range.

It is a fifth object of the present invention to provide a light guide device, which is so configured that when the light-emitting devices emit light onto the light-incident surface of the base, the flat design of the light-incident surface minimizes light reflection and effectively refracts incident light onto the light guide components, thereby increasing the light output and light projection range of light guide device and creating a glare effect.

It is a sixth object of the present invention to provide a light guide device, which is so configured that the light-incident surface of the base is planar, and thus, it does not generate a mold release point when the light guide device is released from the mold during fabrication, thereby simplifying the light guide device fabrication difficulty and allowing mass production of the light guide device.

It is a seventh object of the present invention to provide a light guide device, which is preferably made of polycarbonate, acrylonitrile butadiene styrene copolymer, or a combination of the two. This can make the surface of the light guide device not prone to fogging and blurring when the light guide device is used for a long time, thereby maintaining a good light output rate and achieving the effect of improving the service life of the light guide device.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a light guide device in accordance with the present invention.

FIG. 2 corresponds to FIG. 1 when viewed from another angle.

FIG. 3 is sectional side view, in an enlarged scale, of a part of the light guide device in accordance with the present invention.

FIG. 4 is an exploded view of the present invention before installation of the light guide device in the memory.

FIG. 5 is an elevational view illustrating the light guide device of the present invention installed in the memory.

FIG. 6 is a schematic drawing illustrating the light emitted by the light-emitting devices passed through the light guide device.

FIG. 7 is a sectional side view, illustrating the light guide device of the present invention installed in the memory.

FIG. 8 is an enlarged view of part “a” of FIG. 7.

### DETAILED DESCRIPTION OF THE PREFERRED EMBODIMENT

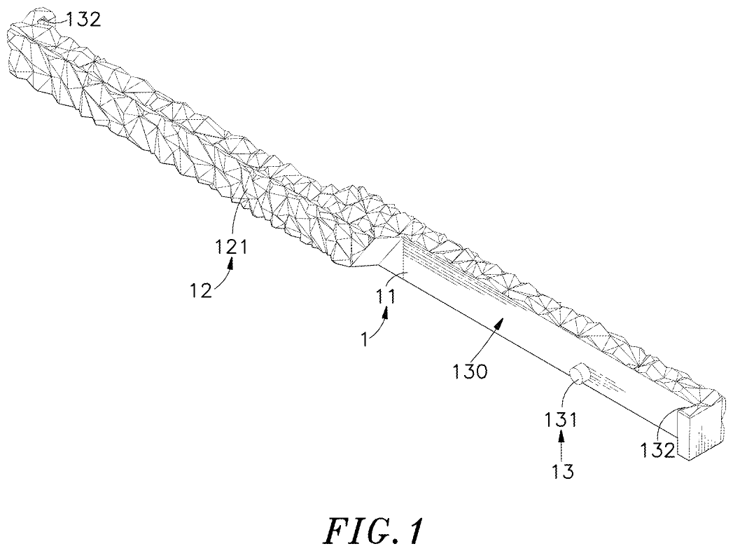

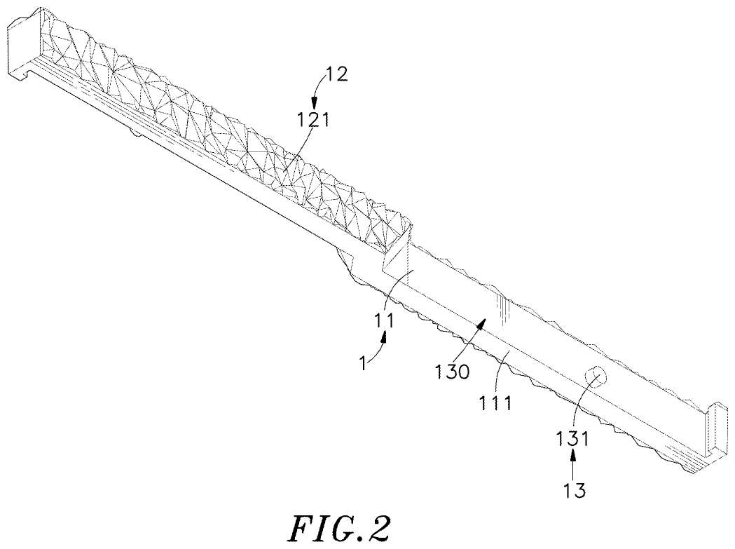

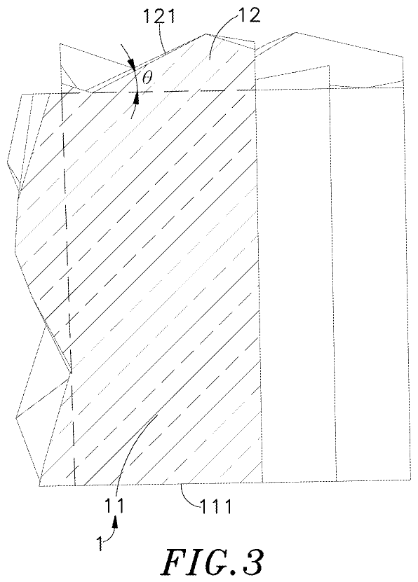

Referring to FIGS. 1-3, an elevational view of a light guide device in accordance with the present invention, another elevational view of the light guide device and a sectional side view of the light guide device are shown. The light guide device 1 comprising a S-shaped base 11 having a planar light-incident surface 111 located on at least one side thereof, a plurality of continuously connected and irregularly configured light guide components 12 located on at least one side of the base 11 and capable of unevenly projecting light passing therethrough toward the outside and respectively provided with at least three light-emitting surfaces 121 that respectively define with the base 11 a respective contained angle θ that causes a glare effect when light passes through the respective light guide component 12, and a mounting structure 13 located on the base 11. At least one contained angle θ of at least one light guide component 12 is different from at least one contained angle θ of another light guide component 12. The mounting structure 13 comprises a plurality of recessed receiving grooves 130 respectively located on left and right sides of the base 11 and facing in opposite directions, a cylindrical positioning column 131 protruded from an inner wall of each recessed receiving groove 130, and two ⊏-shaped hooks 132 respectively located at two opposite ends of the base 11.

The light guide device 1 is made of a light-transmissive material. The light-transmissive material can be selected from the group of polycarbonate (PC), acrylonitrile butadiene styrene (ABS), acrylic, and glass. Preferably, the light guide device 1 is made of polycarbonate or acrylonitrile butadiene styrene copolymer, or a combination of the two. Polycarbonate or acrylonitrile butadiene styrene copolymer has the characteristics of high surface smoothness, high transparency and high heat resistance. Based on characteristics of high surface smoothness, high transparency and high heat resistance, the surface of the light guide device 1 is not prone to matte when used for a long time, prolonging the service life.

Further, before the light guide device 1 is molded and released from the mold (such as a steel mold), the mold can be polished with a diamond paste to make the inner surface of the mold smooth and bright. When the plastic material (such as polycarbonate or acrylonitrile butadiene styrene copolymer, or a combination thereof) is injection-molded and released from the mold, optical facets that are smooth and have better refraction effect are formed on the outer surface of the light guide device 1 thus produced. Since the light-incident surface 111 of the base 11 is flat, when releasing the light guide device 1 from the mold, no uneven release point will be generated, and therefore the light guide device 1 can be smoothly and quickly released from the mold, lowering the difficulty of manufacturing of the light guide device 1 and having the advantage of mass production.

Further, at least two light guide components 12 are formed on the base 11 of the light guide device 1 in a square area of 1 square centimeter. The light guide components 12 of the light guide device 1 can be triangular, tetragonal, pentagonal, hexagonal, heptagonal, octagonal or other irregular shape.

Further, the contained angle θ defined between the base 11 of the light guide device 1 and each light-emitting surface 121 of the light guide component 12 is within the range of 10°˜85°, or preferably 25°˜65°. The angles θ defined between the plurality of light-emitting surfaces 121 of each light guide component 12 and the base 11 can be different from one other by different combinations of cutting angles, so that the outer surface of each light guide component 12 can be formed with different depths and each light guide component 12 with the respective multiple light-emitting surfaces 121 can be shaped like a diamond to have better uneven light-emitting effect.

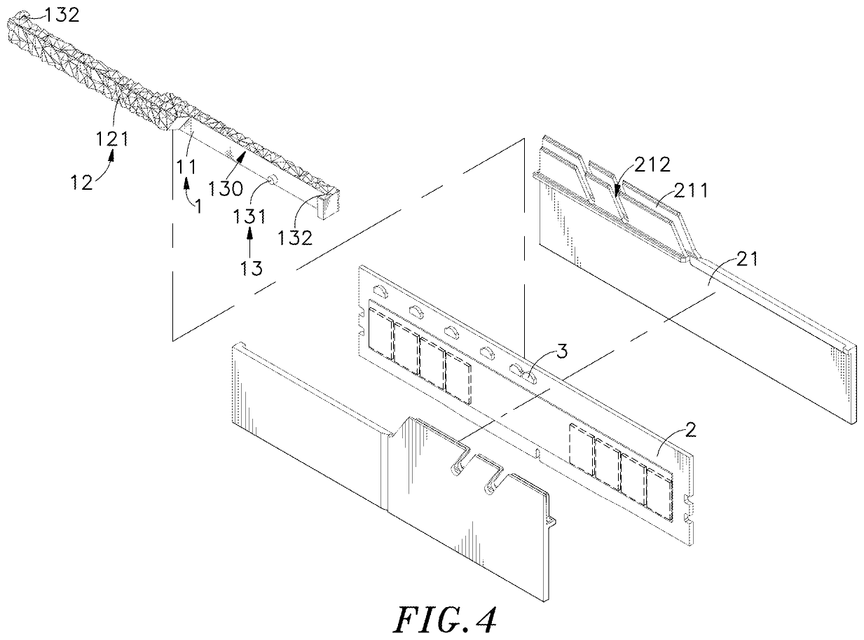

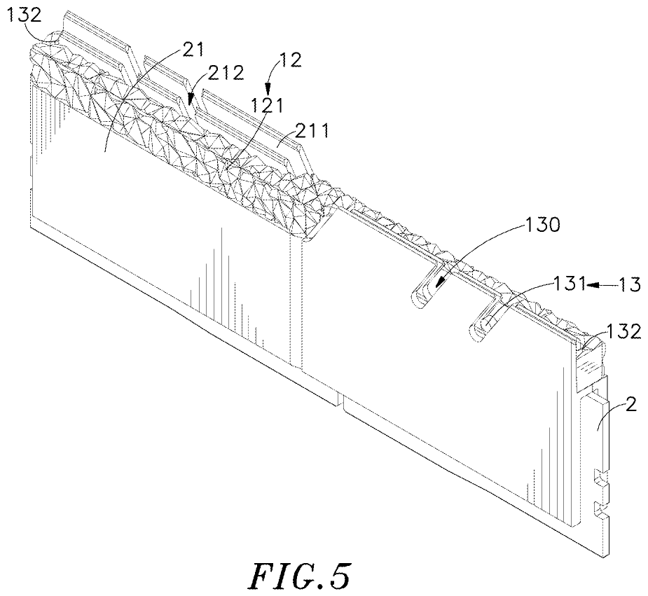

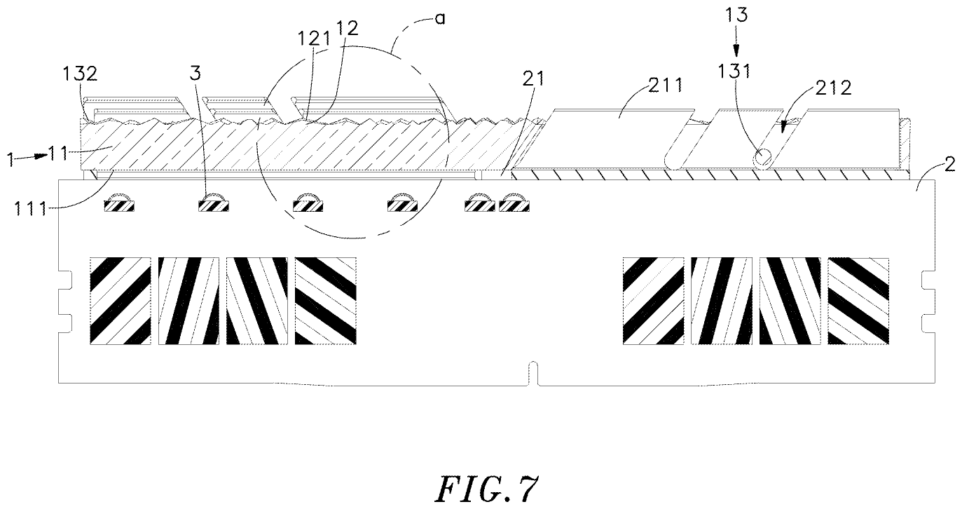

Referring to FIGS. 4-8, an exploded view before installation of the light guide device in a memory, an elevational view after installation of the light guide device in the memory, a schematic drawing during light emitting of the light-emitting device, a sectional side view after installation of the light guide device in the memory and an enlarged view of part “a” of FIG. 7 are shown. It can be clearly seen from the drawings that in the actual use, the light guide device 1 is mounted on a heat dissipating device 21 of a memory 2. The heat dissipating device 21 comprises a plurality of radiation fins 211 located at the top thereof. Each radiation fin 211 has a plurality of positioning slots 212 obliquely downwardly extended from the topmost edge thereof. When mounting the light guide device 1 on the heat dissipating device 21, the radiation fins 211 of the heat dissipating device 21 are respectively received in the recessed receiving grooves 130 of the mounting structure 13, and at the same time, the cylindrical positioning columns 131 of the mounting structure 13 are respectively engaged in respective positioning slots 212 of the heat dissipating device 21, and the two hooks 132 of the mounting structure 13 are respectively hooked on two opposite sides of the heat dissipating device 21. Thus, the light guide device 1 is steadily secured to the heat dissipating device 21 of the memory 2. After the light guide device 1 is secured to the heat dissipating device 21 of the memory 2, the light-incident surface 111 of the base 11 is disposed to face toward the light-emitting side of multiple light-emitting devices 3 at the memory 2.

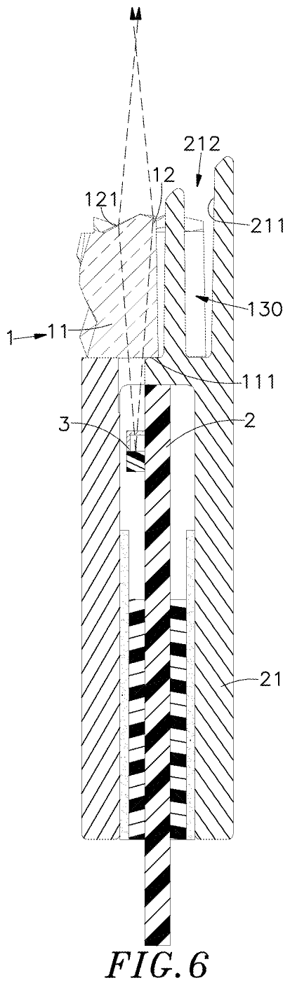

When the light-emitting devices 3 are activated to emit light, the emitted light falls upon the light-incident surface 111 of the base 11, and the incident light is refracted in the base 11 onto the light guide components 12 where the light guide components 12 project the light through the light-emitting surfaces 121 toward the outside. The arrangement of the light-emitting surfaces 121 enables light rays to be concentrated on the area around the intersections of the light-emitting surfaces 121 (see FIG. 6), thus, the distance from which the light is projected can be increased. Further, because the light guide components 12 on the base 11 are continuously connected and irregularly configured, the light guide components 12 can be used to make the light unevenly emitted and diverted. Thereby, the uniformity of the overall brightness of the light guide device 1 is improved, causing generation of a glare effect and an increase in the light projection range and distance. Thus, the design of the light guide components 12 makes the light guide device 1 more dazzling.

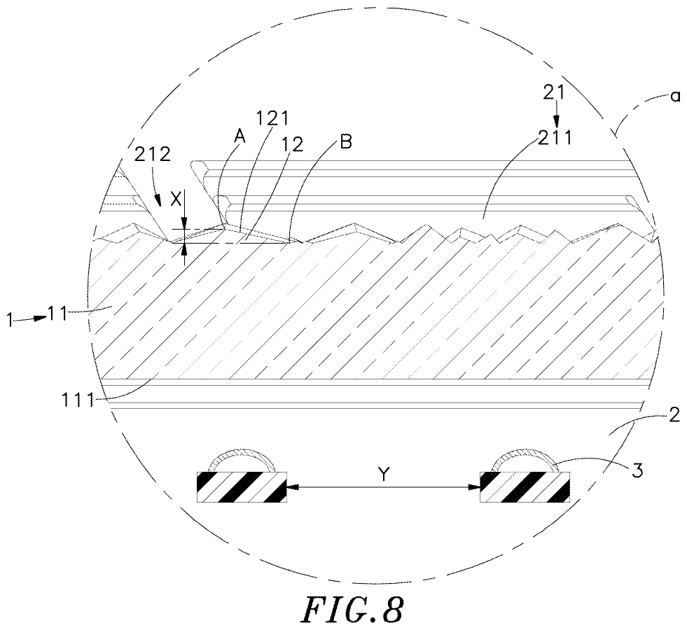

After installation of the light guide device 1 in the memory 2, the direct light emitting directions of the light-emitting devices 3 correspond to the light-emitting surfaces 121 of the respective light guide components 12 (in FIG. 8, the light-emitting devices 3 are disposed right below the light-emitting surfaces 121) but not aimed at the intersections of the light-emitting surfaces 121 (see point A or point B in FIG. 8).

When the light-emitting devices 3 are activated to emit light upward, if the light is projected toward the intersections of the light-emitting surfaces 121, the poor refractive effect at the intersections will make the brightness to be too bright or too dark (e.g. the light will be too bright if the light is emitted from point A, or the light will be too dark if the light is emitted from point B), resulting in poor overall brightness uniformity of the light guide device 1. Therefore, the light-emitting devices 3 are preferably located right below the light-emitting surfaces 121 of the light guide components 12 so that the light can be projected toward the light-emitting surfaces 121 to achieve a good refractive effect, thereby improving the overall brightness intensity and uniformity of the light guide device 1.

Referring to FIG. 8, the height X of the light guide components 12 is preferably within the range of 0.8 mm˜1.2 mm; the pitch Y of the light-emitting devices 3 is 15 mm. Through the above-mentioned size design, the light guide device 1 can produce good light guiding effect in a limited space of a computer or computer peripheral device. As described above, the light-incident surface 111 of the base 11 faces the light-emitting devices 3 and the direct light emitting directions of the light-emitting devices 3 correspond to the respective light guide components 12. Furthermore, the light guide components 12 include two outer light guide components 12 and a plurality of inner light guide components 12 of two different heights alternatively arranged between the two outer light guide components 12, wherein the two outer light guide components 12 are higher than the relatively shorter inner light guide components 12. This arrangement achieves better continuity of the light source, thereby improving brightness uniformity. Since the height of the two outer light guide components 12 is relatively higher than the heights of the inner light components 12, the light projecting distance is effectively increased. In one example of the present invention, the pitch of the light-emitting devices 3 is 15 mm, the height of the two outer light guide components 12 is 1 mm, and the inner light guide components 12 are of two different heights, i.e., 0.8 mm and 1 mm and are alternatively arranged between the two outer light guide components 12. Thus, the light guide device 1 can extend the light source to the next inner light guide component 12 with a height of 1 mm through the adjacent inner light guide component 12 having a height of 0.8 mm, thereby effectively continuing the light source and improving the uniformity of brightness of the light guide device 1 to achieve a good lighting effect.

In the present preferred embodiment, the light guide device 1 is disposed adjacent to the light output direction of the light-emitting devices 3, however, in actual application, the light guide device 1 can be directly attached onto the surface of the light-emitting devices 3. Furthermore, the light-emitting devices 3 are preferably light-emitting diodes (LEDs), however, in actual application, organic light-emitting diodes (OLEDs), incandescent lamps or halogen lamps can be used to replace light-emitting diodes (LEDs).

Preferably, the light guide device 1 is disposed on the heat dissipating device 21 of the memory 2. In actual application, the light guide device 1 can be installed on the cooling fan or CPU inside the computer that is provided with light-emitting devices 3, or directly mounted on light-emitting devices 3 of the computer; alternatively, the light guide device 1 can be used in a light-emitting keyboard or mouse or any other peripheral apparatus that is provided with light-emitting devices 3. Because the light guide device 1 has good light guiding and glare effects when applied to a computer or a computer peripheral apparatus, it can be widely favored by the esports industry manufacturers, thereby improving the overall product competitiveness. According to the preferred embodiment of the present invention, the light guide device 1 uses the recessed receiving grooves 130 of the mounting structure 13 to receive the radiation fins 211 of the heat dissipating device 21 and uses the cylindrical positioning columns 131 and the hooks 132 for mounting. In actual application, clamps, pins or other positioning devices can be used to secure the light guide device 1 to the heat dissipating device 21. There are many ways for the light guide device 1 to be combined with the heat dissipating device 21, so that any structure that can achieve the aforementioned effects should be covered by the present invention, and such simple modifications and equivalent structural changes should be included in the present invention.

In addition, the light-incident surface 111 of the base 11 of the light guide device 1 is planar. When the at least one light-emitting device 3 emits light onto the light-incident surface 111 of the base 11, the light-incident surface 111 minimizes light reflection, so that the incident light can be accurately refracted onto the light guide components 12 to prevent light leakage, thereby increasing the light output of lightguide device 1 and the light projection range.

In addition, because a contained angle θ within the range of 10°˜85° is defined between the base 11 of the light guide device 1 and each light-emitting surface 121 of each light guide component 12, when the at least one light-emitting device 3 emits light onto the light guide device 1, the different angles of light-emitting surfaces 121 of the light guide components 12 can refract light in different light paths, causing non-uniform outward scattering of light. Therefore, the contained angle θ can be used to reduce the occurrence of backward light refracting, thereby increasing the light extraction rate and refractive index of the light guide components 12.

In conclusion, the invention has the advantages as follows:

1. The arrangement of the continuously connected and irregularly configured light guide components 12 on at least one side of the base 11 of the light guide device 1 is capable of unevenly projecting light passing therethrough toward the outside, therefore, the light guide components 12 guide the light to the entire light guide device 1 to improve the uniformity of the overall brightness of the light guide device 1, enabling the light guide device 1 to emit a transparent and bright aesthetic sense. Uniform brightness can be used to prevent the viewer from seeing the light-emitting devices 3 directly, avoiding glaring and uncomfortable eyes. In addition, since the at least one contained angle θ of the at least one light guide component 12 is different from the at least one contained angle θ of another light guide component 12, the plural light guide components 12 of the light guide device 1 can make the light emitted by the light-emitting devices 3 to be unevenly outputted, which can effectively increase the range and distance of light projection, and can produce a glare effect that looks like aurora. In this way, the light output effect can be more dazzling and gorgeous, so as to improve the aesthetics of the projected light, thereby increasing the consumer's desire to buy.

2. The light guide device 1 uses the continuously connected and irregularly configured light guide components 12 to improve the overall brightness uniformity and the light projection distance and range. Therefore, the amount of light diffusing agent can be reduced or no light diffusing agent is required. Thus, the quantity of the light-emitting devices 3 can be minimized, reducing the overall manufacturing cost. Furthermore, the light emitted by the light-emitting devices 3 is refracted by the light guide components 12, avoiding uneven brightness and fogging, so that it can have better brightness uniformity and increased projection distance and projection range.

3. After installation of the light guide device 1 on the memory 2, the light-emitting devices 3 are located right below the light-emitting surfaces 121 of the light guide components 12 and are not located at the intersections of the light-emitting surfaces 121. When the light-emitting devices 3 emit light upward, the light-emitting surfaces 121 produce good refracting effects without refracting light onto the intersections of the light-emitting surfaces 121, eliminating the problem of being too bright or too dark and further improving the overall brightness intensity of the light guide device 1 and the brightness uniformity.

4. The light guide components 12 that are arranged on the light guide device 1 to face the light-emitting devices 3 include two outer light guide components 12 and a plurality of inner light guide components 12 of two different heights alternatively arranged between the two outer light guide components 12, and the two outer light guide components 12 are higher than the relatively shorter inner light guide components 12. This arrangement achieves better continuity of the light source, thereby improving brightness uniformity. Since the two outer light guide components 12 is relatively higher than inner light guide components 12, the light projecting distance is effectively increased. This can improve the uniformity of brightness, as well as the effect of light output distance and range.

5. When the light-emitting devices 3 emit light onto the light-incident surface 111 of the base 11, the flat design of the light-incident surface 111 minimizes light reflection and effectively refracts incident light onto the light guide components 12, thereby increasing the light output and light projection range of light guide device 1 and creating a glare effect.

6. Because the light-incident surface 111 of the base 11 is planar, it does not generate a mold release point when the light guide device 1 is released from the mold during fabrication, and thus, the light guide device 1 fabrication difficulty is reduced. This allows the light guide device 1 to be mass produced through molds.

7. The light guide device 1 is preferably made of polycarbonate, acrylonitrile butadiene styrene copolymer, or a combination of the two. This can make the surface of the light guide device 1 not prone to fogging and blurring when the light guide device 1 is used for a long time, thereby maintaining a good light output rate and achieving the effect of improving the service life of the light guide device 1.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A light guide device for use in computers and computer peripheral devices to improve brightness uniformity, comprising a base provided with a light-incident surface at one side thereof to face a light-emitting side of a plurality of predetermined light-emitting devices and a plurality of continuously connected and irregularly configured light guide components located on at least one side of said base for improving the uniformity of brightness, each said light guide component comprising at least three light-emitting surfaces for refracting incident light, each said light-emitting surface defining with said base a respective contained angle within the range of 10°˜85° for causing a glare effect when light passes through the respective said light guide component, at least one contained angle of said at least one light guide component is different from the at least one contained angle of another said light guide component.

2. The light guide device as claimed in claim 1, wherein at least two said light guide components are formed on said base in a square area of 1 square centimeter.

3. The light guide device as claimed in claim 1, wherein said light-incident surface of said base is planar.

4. The light guide device as claimed in claim 1, wherein the contained angle defined between each said light-emitting surface defining and said base is preferably within the range of 25°˜65°.

5. The light guide device as claimed in claim 1, wherein said light guide components are selectively triangular, tetragonal, pentagonal, hexagonal, heptagonal or octagonal shape.

6. The light guide device as claimed in claim 1, wherein the height of each said light guide component is within the range of 0.8 mm˜1.2 mm; the pitch of said predetermined light-emitting devices is 15 mm.

7. The light guide device as claimed in claim 1, further comprising a mounting structure located on said base, said mounting structure comprising a plurality of recessed receiving grooves respectively located on opposing left and right sides of said base and facing in opposite directions, a cylindrical positioning column protruded from an inner wall of each said recessed receiving groove, and two hooks respectively located at two opposite ends of said base in reversed directions.

8. A light guide device for use in computers and computer peripheral devices to improve brightness uniformity, comprising a base provided with a light-incident surface at one side thereof to face a light-emitting side of a plurality of predetermined light-emitting devices and a plurality of continuously connected and irregularly configured light guide components located on at least one side of said base for improving the uniformity of brightness, each said light guide component comprising at least three light-emitting surfaces disposed corresponding to said light-emitting surfaces of the respective said light guide components for refracting incident light, each said light-emitting surface defining with said base a respective contained angle within the range of 10°˜85° for causing a glare effect when light passes through the respective said light guide component, at least one contained angle of said at least one light guide component is different from the at least one contained angle of another said light guide component, said light guide components including two outer light guide components and a plurality of inner light guide components of two different heights alternatively arranged between said two outer light guide components, the height of said two outer light guide components being larger than the heights of said inner light guide components.

9. The light guide device as claimed in claim 8, wherein at least two said light guide components are formed on said base in a square area of 1 square centimeter.

10. The light guide device as claimed in claim 8, wherein said light-incident surface of said base is planar.

11. The light guide device as claimed in claim 8, wherein the contained angle defined between each said light-emitting surface defining and said base is preferably within the range of 25°˜65°.

12. The light guide device as claimed in claim 8, wherein said light guide components are selectively triangular, tetragonal, pentagonal, hexagonal, heptagonal or octagonal shape.

13. The light guide device as claimed in claim 8, wherein the height of each said light guide component is within the range of 0.8 mm˜1.2 mm; the pitch of said predetermined light-emitting devices is 15 mm.

14. The light guide device as claimed in claim 8, further comprising a mounting structure located on said base, said mounting structure comprising a plurality of recessed receiving grooves respectively located on opposing left and right sides of said base and facing in opposite directions, a cylindrical positioning column protruded from an inner wall of each said recessed receiving groove, and two hooks respectively located at two opposite ends of said base in reversed directions.
